(19) United States
(12) Patent Application Publication
(10) Pub. No.: US 2012/0260201 A1
(43) Pub. Date: Oct. 11, 2012

(54) COLLECTION AND ANALYSIS OF SERVICE, PRODUCT AND ENTERPRISE SOFT DATA

(75) Inventors: Jai Ganesh, Bangalore (IN); Shaurabh Bharti, Munger (IN)

(73) Assignee: Infosys Technologies Ltd., Bangalore (IN)

(21) Appl. No.: 13/111,703

(22) Filed: May 19, 2011

(30) Foreign Application Priority Data
Apr. 7, 2011 (IN) 1206/CHE/2011

(51) Int. Cl. G06F 3/048

(52) U.S. Cl. 715/764

(57) ABSTRACT

Tools and techniques are provided that capture, aggregate, analyze and display soft data relating to an enterprise's services and products, and to the enterprise itself. The soft data comprises customer feedback on services, products and the enterprise, and are based on interactions between enterprise employers and the customers. The soft data comprises quantitative ratings and qualitative comments and is entered by employees at a capture engine. The captured soft data is aggregated and analyzed by an analytics engine, thereby generating aggregate data for use in generating data clouds at a display. Data clouds comprise service, product and enterprise attributes that are weighted according to quantitative rankings and qualitative comments relating to the attributes. Enterprise employees having decision-making authority can request data clouds for display, which can aid the decision makers in making decisions relating to enterprise services and products, and to the enterprise itself.

### BACKGROUND

Enterprises seek feedback on the services and products they provide, along with feedback on the enterprise itself, in order to improve their offerings and operations. Market surveys sent out to customers are one way that such feedback can be captured. However, market surveys may not capture all available customer feedback, as customers may not wish to take the time to fill out such surveys. Further, market surveys may not capture customers' true sentiments about a service, product or enterprise as the customer may wish to provide feedback on a service, product or enterprise attribute not covered by the survey. Existing market surveys may ask a customer to provide feedback in the form of comments, but these comments may simply be provided to an enterprise in list form, with little or no analysis of the comments performed.

Thus, there is a need for improved tools and techniques for collecting, analyzing and presenting customer feedback on enterprises, and the products and services that they offer.

### SUMMARY

This Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter.

As described herein, employees of an enterprise can collect feedback on an enterprise's services or products, and on the enterprise itself, based on interaction with customers of the enterprise. This feedback can be collected in the form of soft data relating to various service, product and enterprise attributes from employees located across multiple stores or other places where the enterprise does business. The collected data can be aggregated and analyzed, and provided to enterprise employees in data cloud form upon request. The data cloud provides enterprise employees with a visual representation of the aggregated soft data in a form that is easy to comprehend. Enterprise employees can view the aggregate data underlying any individual attribute in the data cloud for detailed customer feedback.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE DRAWINGS

FIG. 1 is a block diagram of an exemplary system for capturing and analyzing service, product and enterprise soft data.

FIG. 2 is a flowchart of an exemplary method of capturing soft data relating to a service, product or enterprise.

FIG. 3 is a screenshot of an exemplary capture engine interface for capturing service attribute soft data.

FIGS. 4-5 are screenshots of an exemplary capture engine interface for capturing product attribute soft data.

FIGS. 6-7 are screenshots of an exemplary capture engine interface for capturing enterprise soft data.

FIG. 8 is a flowchart of an exemplary method of aggregating and analyzing soft data.

FIG. 9 is a screenshot 900 of an exemplary data cloud.

FIG. 10 is a diagram of a screen of an exemplary mapping software application capable of displaying data clouds for one or more stores.

FIG. 11 is a diagram of a screen of an exemplary mapping software application showing a data cloud for a selected store.

FIG. 12 is a flowchart of an exemplary method of displaying a data cloud.

FIG. 13 is an exemplary system of capturing, aggregating and analyzing soft data in a retail store enterprise context.

FIG. 14 is a flowchart of an exemplary method of receiving and aggregating soft data, and providing data for displaying a data cloud.

FIG. 15 is a block diagram depicting an exemplary computing environment for collecting and analyzing soft data via a peer-to-peer model.

### DETAILED DESCRIPTION

### Example 1

### Exemplary System for Constructing a Decision Tree

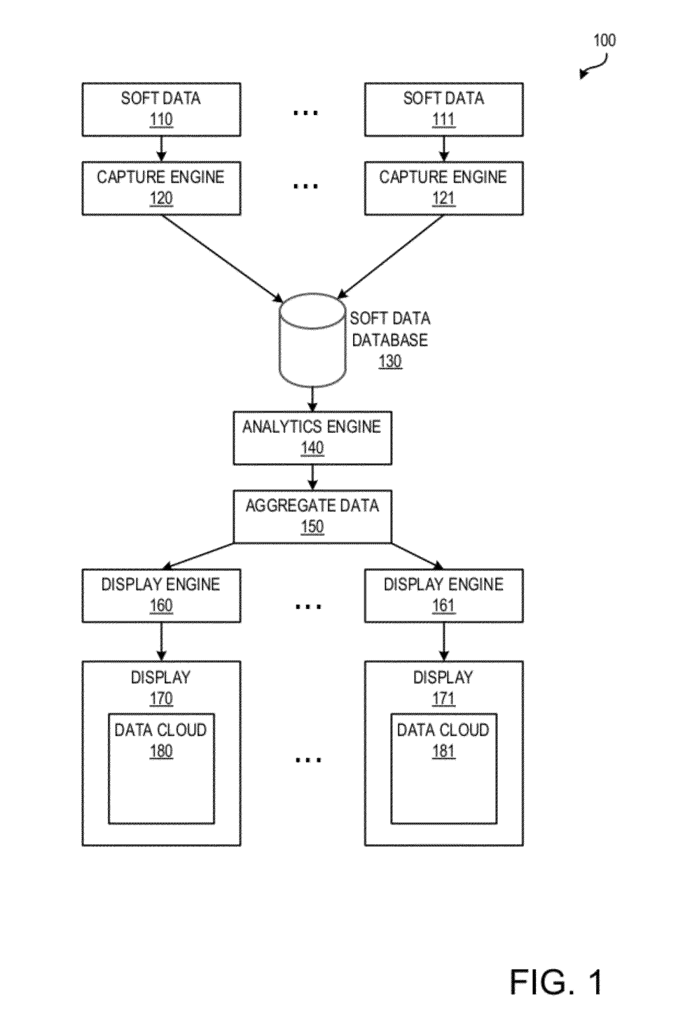

FIG. 1 is a block diagram of an exemplary system 100 for collecting, aggregating and analyzing soft data 110-111, and for displaying the analyzed soft data as data clouds 180-181 at displays 170-171. The system 100 and variants of it can be used to perform any of the methods described herein.

In the exemplary system 100, capture engines 120-121 located at multiple stores or other locations where an enterprise does business receive soft data 110-111 from the enterprise's employees. The soft data is based on customer feedback and relates to the enterprise's service or products, or to the enterprise itself. The captured soft data is stored at a soft data database 130. An analytics engine 140 retrieves soft data from the soft data database 130, and aggregates and analyzes the soft data to generate aggregate data 150. In response to requests from enterprise employees having decision-making authority with respect to enterprise services and products, or other enterprise-level concerns, the aggregate data 150 is provided to display engines 160-161 for display at displays 170-171 in the form of data clouds 180-181.

### Example 2

### Exemplary Soft Data

In any of the examples herein, “soft data” refers to information capturing a person's impressions, opinions, perceptions, views or other feedback about an enterprise's services or products, or about the enterprise itself. Soft data can relate to various service, product or enterprise attributes such as product quality and price, customer support responsiveness, convenience of store location and hours, the enterprise's name and reputation, and the like. In a specific implementation, soft data refers only to people's subjective feedback. Soft data is in contrast to “hard data,” which generally refers to information reflecting more measurable features or objective descriptions of an object, service or entity. Examples of hard data include statements such as “brand X products meet all government reliability standards,” “television Y has a 45-inch screen,” “speakers Z cost $2,000,” and “Store X is open from 10:00 AM to 6:00 PM on the weekends.”

Soft data can be comprised of quantitative and/or qualitative data. Examples of qualitative soft data include comments such as “brand X products are reliable,” “television Y has a large screen,” “speakers Z are too expensive” and “store X closes too early on the weekends.” An example of quantitative soft data includes quantitative rankings, such as a person giving brand X products four out of five stars for quality.

### Example 3

### Exemplary Enterprises and Services

In any of the examples herein, an enterprise refers to any organization that offers products and/or services, regardless of whether the enterprise operates for profit. Thus, an enterprise can refer to organizations that, for example, predominantly offer products (e.g., retail stores), predominantly offer services (e.g., restaurants, package delivery services) or non-profit organizations that provide services and products to the public. Accordingly, “employees” as used herein, refer to people who work for an enterprise, regardless of whether they are paid, and “customers” and “clients” refer to people who pay for or otherwise receive a service or product offered by the enterprise. Employees that provide soft data about services, products and an enterprise to a capture engine can be any person that interacts with customers or clients of an enterprise. Such employees include retail store checkout clerks, sales staff and customer service persons (in-person, over-the-phone, or on-line), wait staff at a restaurant, journeymen who make house calls such as plumbers or electricians, or volunteers working for a non-profit. In a specific implementation, soft data is only provided by employees.

In any of the examples described herein, “services” can refer to services provided by an organization (e.g., electrical, plumbing or delivery services), or the level of customer service provided by the enterprise (e.g., the friendliness of the employees, convenience of hours of operation, convenience of location of a store).

### Example 4

### Exemplary Capture Engine

In any of the examples herein, a capture engine provides an interface for capturing or collecting soft data provided to an enterprise employee by a customer. An employee can gather customer feedback on a service, product or enterprise by, for example, having a customer fill out a survey or through casual conservation with the customer. An employee can also enter soft data based on their own perceptions of a service, product, or the enterprise, resulting from, for example, the employee's familiarity with enterprise services or products, or the enterprise itself.

The capture engine can be one or more of (or a part of) any computing device described herein. A capture engine can be, for example, a desktop computer used as a checkout machine or a dumb terminal in communication with a computing device, or any other computing device that allows enterprise employees to enter customer feedback in a convenient manner.

For example, in a retail store environment, a checkout person could enter customer feedback at a checkout machine during a break between customers, or after helping a customer on the store floor. Employees can be required to login and be authenticated prior to entering data to ensure that soft data is collected from only authorized employees. In a service provider environment, an employee providing services at a customer's home or place of business (e.g. plumbers, electricians, deliverymen) can enter customer feedback on a tablet computer or other mobile device while on site. The data entered in mobile devices can be downloaded to a soft data database when, for example, the mobile device is docked for charging back at a service center.

Any number of capture engines can be located in a single store, and multiple capture engines can be located in multiple stores.

### Example 5

### Exemplary Method of Capturing Service, Product or Enterprise Soft Data

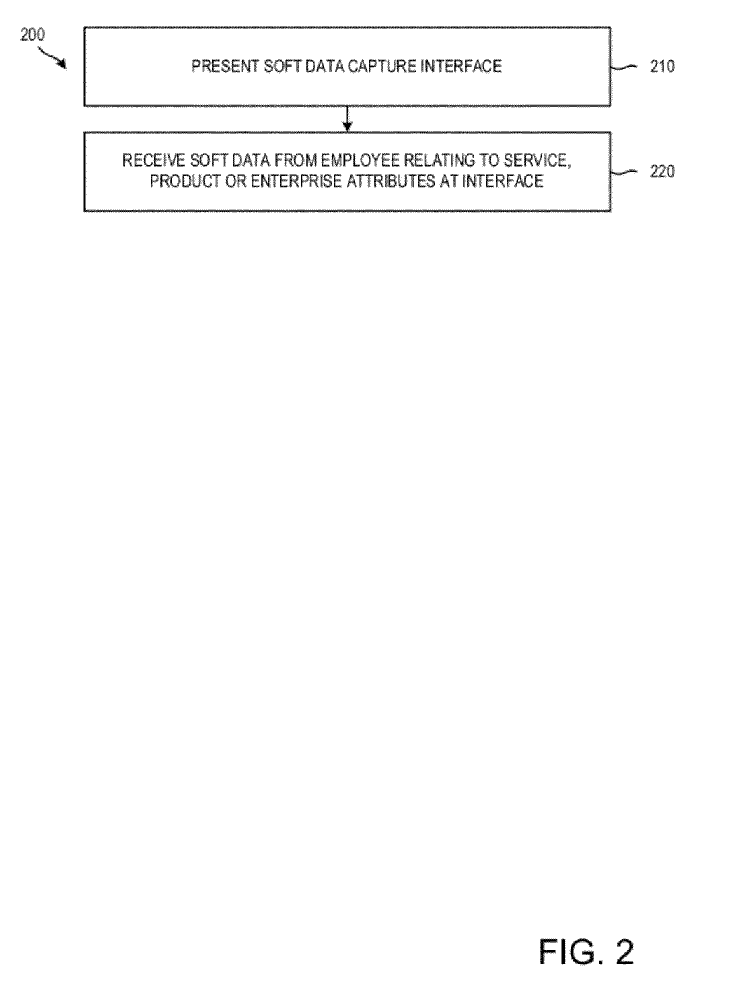

FIG. 2 is a flowchart of an exemplary method 200 of capturing soft data relating to a service, product or enterprise.

At 210, a capture engine presents a soft data capture interface.

At 220, soft data regarding one or more service, product or enterprise attributes is received from an enterprise employee at the soft data capture interface.

In some embodiments, the method 200 can additionally comprise storing the received input as soft data. In some embodiments, the method 200 can additionally comprise a user adding a new attribute to the plurality of service, product and enterprise attributes displayed in the soft data capture interface, and capturing soft data related to the new attribute.

### Example 6

### Exemplary Soft Data Capture Interface

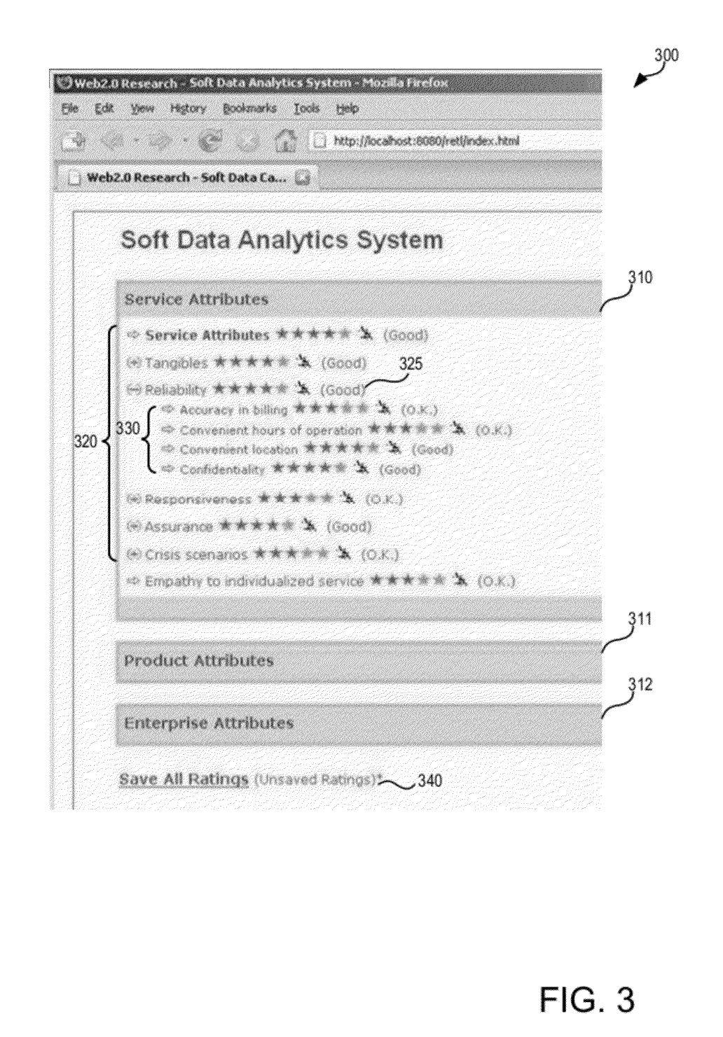

FIGS. 3-7 are screen shots of an exemplary web-based soft data capture interface presented by a capture engine. FIG. 3 is a screenshot 300 of an exemplary capture interface for capturing soft data related to a service. The screenshot 300 comprises drop-down menus 310-312 for entering soft data relating to a service, product or enterprise. The menus 310-312 can be expanded to reveal a plurality of attributes for which soft data can be provided. For example, the service attribute menu 310 has been expanded to reveal a plurality of attributes 320 relating to the service provided by an enterprise: Service Attributes, Tangibles, Reliability, Responsiveness, Assurance, Crisis scenarios and Empathy to individualized service. The Service Attributes can be an attribute for capturing soft data regarding the service provided by the enterprise as a whole, or it can be an attribute that is an aggregate of the quantitative soft data provided for the remainder of the listed service attributes (i.e., it is calculated from the other attributes). In some embodiments, the list of service attributes 320 can include an additional attribute (e.g., Service) that allows the employee to select a service provided by the enterprise for which the employee is entering data (e.g., auto repair, computer training).

Any of the attributes 320 can be associated with one or more sub-attributes. For example, the Reliability attribute 325 has been expanded to reveal four sub-attributes 330: Accuracy in billing, Convenient hours of operation, Convenient location and Confidentiality. The series of stars next to the attributes in the screenshot 300 provides a manner of capturing quantitative feedback from an enterprise customer for a given attribute. For example, in the five-star rating system displayed in FIG. 3, an employee can click on one to two stars to enter “Bad” feedback for a service attribute, three stars for “O.K.” feedback, and four or five stars for “Good” feedback. Once a quantitative rating (i.e., a star rating) for an attribute is entered, the capture engine can display whether the rating reflects good, bad or O.K. feedback. For example, the entry of a three-star quantitative rating for the “Convenient hours of operation” attribute, causes the capture engine to display the “(O.K.)” indication next to the attribute.

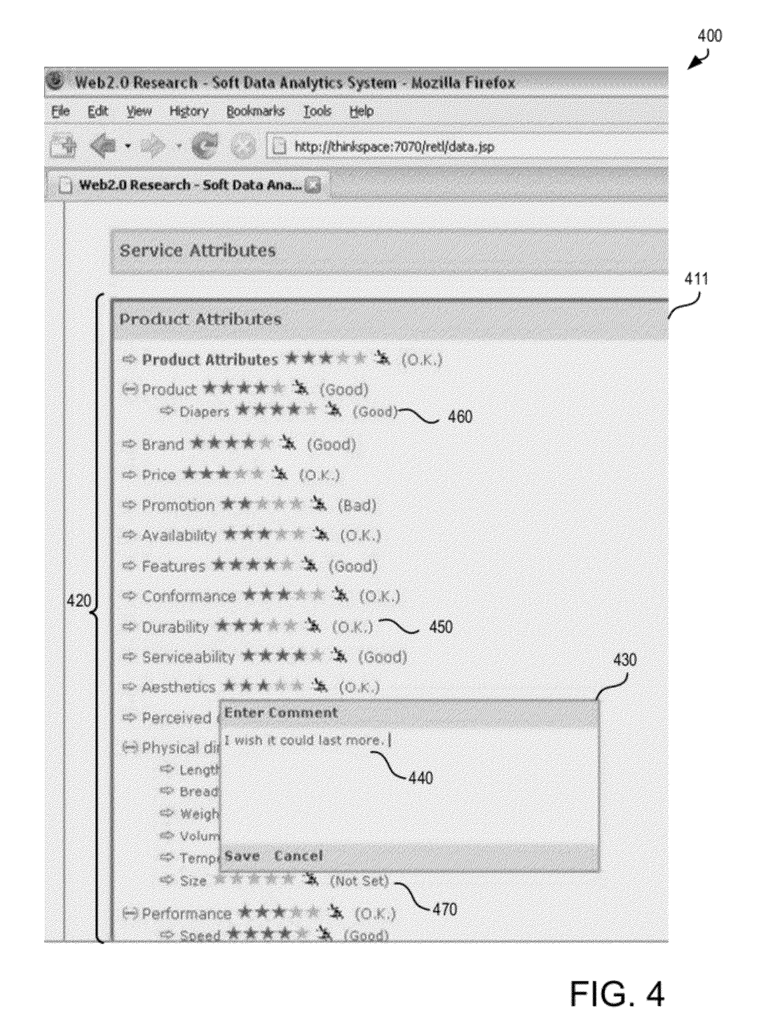

Although screenshots 300 and 400 show quantitative feedback having been provided for most of the attributes displayed, an employee can provide soft data for any number of attributes. For example, with reference to FIG. 4, no quantitative rating has been provided for the sub-attribute “Size” for attribute “Physical dimensions,” which is indicated by “(Not Set)” indicator 470 being displayed next to the attribute. In some embodiments, the capture engine can allow the employee to add a new service, product or enterprise attribute. Soft data previously entered can be modified or deleted by an employee. In addition, the service, product and enterprise drop-down menu can contain a catchall attribute to capture qualitative comments for attributes not listed in the menu.

Once an employee has finished entering soft data, the employee clicks on “save all ratings” to save the data. The captured data can be saved to the soft data database, or to memory local to the capture engine (e.g., a computer's RAM or hard drive) to be downloaded to the soft data database later.

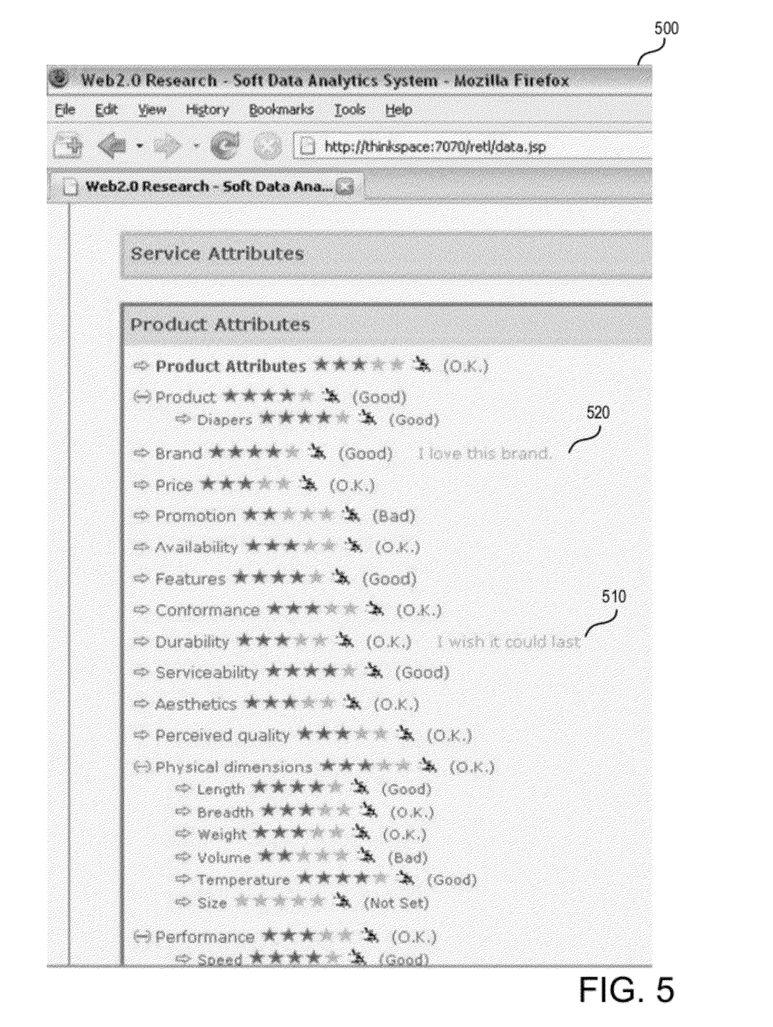

FIGS. 4-5 are screenshots of an exemplary capture interface for entering soft data related to a product sold by an enterprise. The screenshot 400 shows the product attributes menu 411 expanded to reveal a list of product attributes 420. The screenshot 400 further shows that the capture engine is capable of accepting qualitative comments related to any of the displayed service, product or enterprise attributes. In some embodiments, the employee can bring up a comment window, for example, by clicking on the attribute name, which allows for entry of a qualitative comment. Screenshot 400 shows the qualitative comment 440 “I wish it could last more” being entered for the “Durability” product attribute 450 for the selected “Diapers” product 460. FIG. 5 is a screenshot 500 of the capture interface after qualitative comments have been entered by the employee. Screenshot 500 shows, for example, qualitative comments 510 and 520 that have been entered for the “Durability” and “Brand” product attributes, respectively.

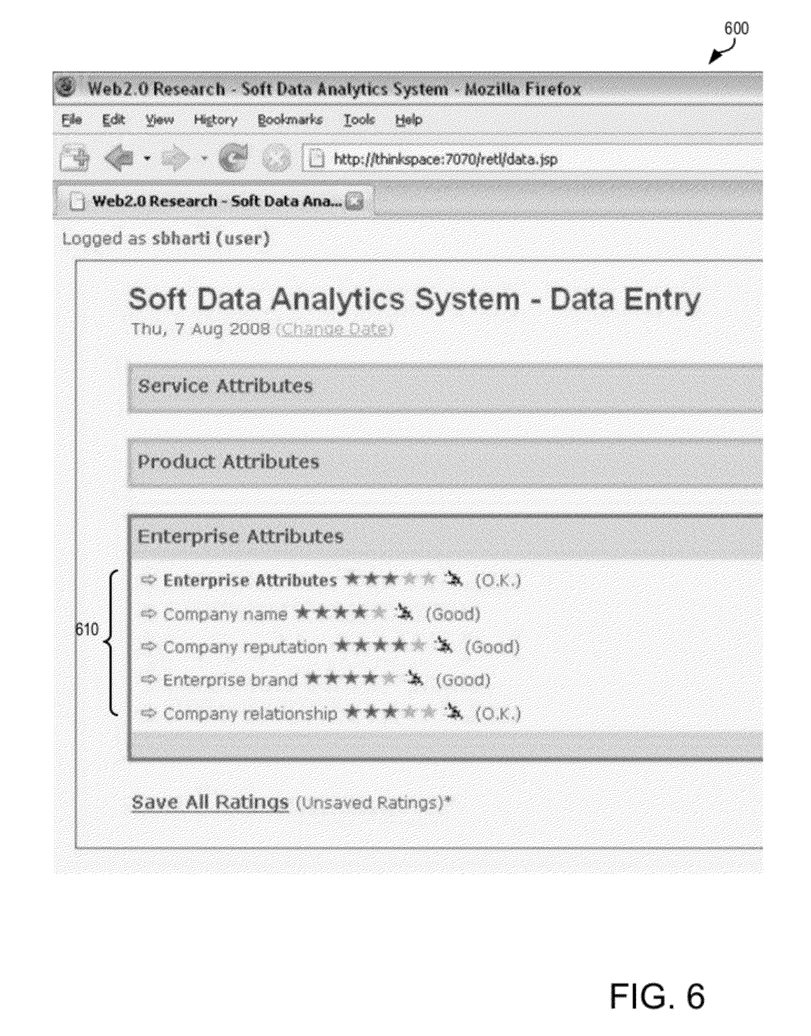

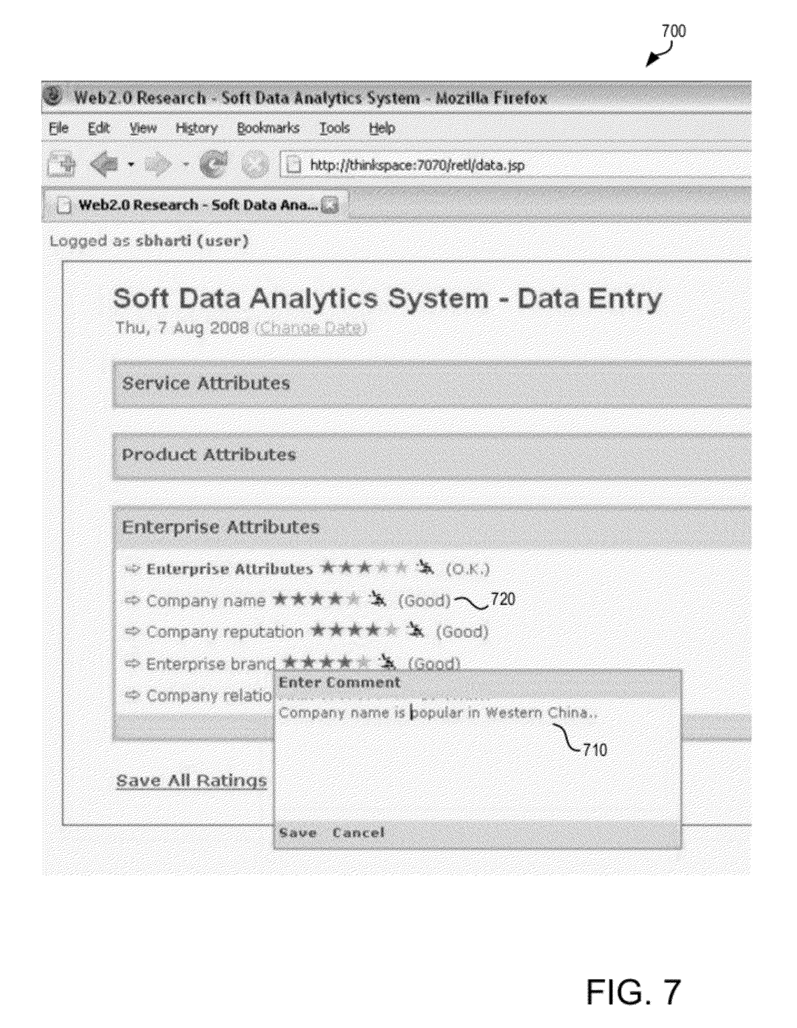

FIGS. 6-7 are screenshots 600 and 700, respectively, of a capture engine interface with the enterprise attribute drop-down menu expanded. Screenshot 600 shows the entry of qualitative data for five enterprise attributes 610: Enterprise Attributes, Company Name, Company reputation, Enterprise brand and Company relationship. Screenshot 700 shows the qualitative comment 710 “Company name is popular in Western China” being entered for the Company name attribute 720.

Although the interface shown in FIGS. 3-7 is a web-based interface, the capture engine can collect customer feedback via any other application that presents an employee with a user interface capable of receiving service, product and enterprise soft data.

### Example 7

### Exemplary Soft Data Database

In any of the examples herein, a soft data database contains soft data captured by a capture engine. A soft data database can be a centralized or distributed database. For example, a central soft data database can be located at an enterprise's headquarters or at a data center. A distributed soft data database can be a collection of databases that individually store data from several capture engines, or local memory to any number of computing devices comprising a capture engine (e.g. a desktop computer acting as a checkout machine or a tablet computer). The captured soft data can be written to a soft database at periodic intervals or on demand. The soft data database can be any computing device possessing sufficient storage capacity to store the captured soft data, or any stand-alone memory device, as is known in the art.

### Example 8

### Exemplary Analytics Engine

In any of the examples herein, an analytics engine receives soft data from the soft data database for aggregation and/or analysis. The analytics engine can be a computing device that is separate from or that comprises the soft data database. For example, the analytics engine can be a software application that is executed on a computer that also contains the soft data database. In embodiments where the analytics engine is part of a separate computing device from the soft data database, the analytics engine is capable of connecting to the soft data database, for example, through a network such as the Internet.

Aggregation comprises organizing the soft data received from the soft data database by service, product or enterprise attribute. The received soft data can be further organized by store, stores within a geographical region (e.g., country, state, city, sales region), time period (e.g., month, week, day, work shift (morning, evening weekend)), employee or the like.

Analysis of the soft data comprises analyzing the quantitative and qualitative soft data to generate aggregate data. For the service, product or enterprise attributes, analysis of the quantitative soft data can comprise, for example, calculating the average or median quantitative rating, determining the maximum or minimum quantitative rating, or calculating any other statistical measure, or performing any other statistical analysis as is known in the art. The aggregate data can include any calculated or determined metric for any attribute.

Analysis of the qualitative soft data can comprise searching qualitative comments against a set of keywords to identify whether the comments indicate positive, negative or neutral feedback. For example, comments containing keywords such as “excellent, superior, happy, enjoyable” can be identified as positive comments and comments containing keywords such as “unhappy, inferior, low-quality” can indicate negative feedback. Individual qualitative comments containing positive or negative keywords can be flagged as “positive” or “negative” accordingly, and this information can be contained in the aggregate data. Analysis of the qualitative soft data can also comprise calculating the frequency of keywords in the qualitative comments. Keyword frequency can be calculated for the qualitative comments as a whole, for individual comments, or for a subset of qualitative comments (e.g., those relating to a particular attribute, product or store).

Analysis of the received soft data also comprises generating weighting data. Generally, weighting data indicates how visual properties of terms (or tags) in a data cloud are to be varied, based on a metric associated with the terms. For example, in a tag cloud (one example of a tag cloud), font size and color of terms can be varied according to the frequency with which the terms appear in a document, web page/site or other dataset. In the technologies disclosed herein, weighting data can indicate, for example, how the font size and/or color of attribute names are to be displayed in a data cloud.

For example, an attribute for which positive soft data has been received can have associated weighting data indicating that the attribute name is to be displayed in a relatively larger font size or a first color (e.g., green). Similarly, weighting data for an attribute for which neutral feedback has been received can indicate that the attribute name be displayed in a normal font size and a second color (e.g., yellow), and weighting data for attributes for which negative feedback has been received can indicate that the attribute be displayed in a relatively small font size and/or a third color (e.g., red). In some embodiments, an overall (e.g., average, median) quantitative ranking of four stars out of five or higher can be considered to be positive feedback, an overall ranking of three to four stars can be considered to be neutral feedback, and an overall ranking of three stars or less can be considered to be negative feedback. Weighting data can indicate that visual properties other than font size and color can be varied. For example, weighting data can indicate that attributes receiving negative feedback are flashed when displayed.

Aggregate data, including weighting data, can be generated for all of the soft data or for any subset of the soft data associated with an attribute. For example, aggregate data can be calculated from quantitative ratings for attributes for a given store or for individual comments pertaining to a specific set of products. Further, the aggregate data can include any data generated during the aggregation and analysis phase, as well as any portion or all of the soft data received by the analytics engine. The aggregate data can be stored in any appropriate data structure known in the art.

Aggregation and analysis can be performed at periodic intervals or on-demand by enterprise employees. Generally, weighted data can be generated for soft data received in a recent time period (i.e., the last day, week, month, quarter, year). Weighted data can also be calculated for various subsets of aggregate data, such as by one or more stores (i.e., by country, state, city), work shift (e.g., morning, evening, weekend), customer characteristics (e.g., male/female, child/adult) or by employee. Weighted data can be calculated for various combinations of aggregate data subsets as well (e.g., feedback provided to employees working weekend shifts for all stores in New York City over the past month). Given the large number of possible sets of weighted data that can be generated, an analytic engine can generate weighted data on demand.

### Example 9

### Exemplary Method of Aggregating and Analyzing Soft Data

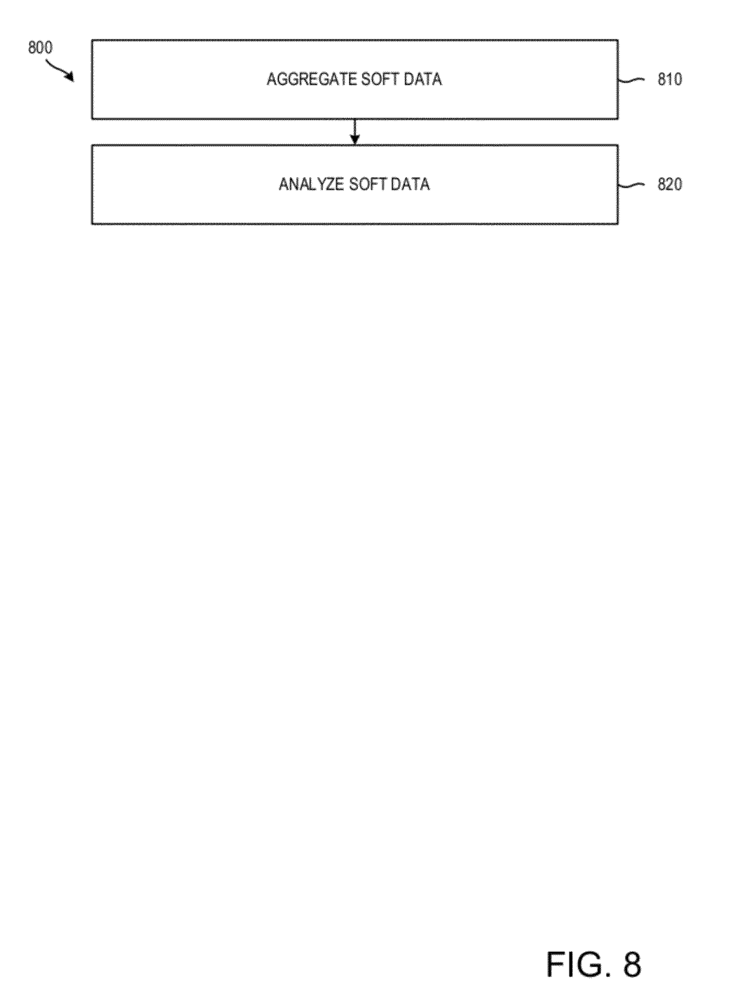

FIG. 8 is a flowchart of an exemplary method 800 of aggregating and analyzing soft data.

At 810, the received soft data is aggregated.

At 820, the received soft data is analyzed. Analysis of the soft data can comprise analyzing the quantitative soft data, analyzing the qualitative soft data and determining weighting data for the service, product and enterprise attributes. Aggregate data is generated as a result of aggregating and/or analyzing the soft data.

### Example 10

### Exemplary Display Engine

In any of the examples described herein, a display engine causes data clouds to be displayed at a display. The display engine can be any (or part of any) computing device described herein in communication with display, such as a desktop computer connected to a local display, a server in connection with any number of remote displays, or a laptop or any other mobile device having an integrated display. The display engine can be configured to produce data clouds in response to requests submitted by enterprise employees. Generally, the requesting enterprise employees are those having enterprise-level decision-making authority, or decision-making authority for an enterprise product or service. For example, the display engine could be a desktop computer in the office of a retail store enterprise employee responsible for purchasing retail store inventory.

In some embodiments, the data cloud can be displayed at displays accessible to any enterprise employee. For example, retail store employees that interact with customers can view the data clouds at a display located on the floor of the retail store. In such embodiments, the display engine can be the same computing device as the capture engine. As such, the techniques for collecting, aggregating, analyzing and displaying soft data can be considered a peer-to-peer model.

In some embodiments, a display engine can be the same computing device as the analytic engine. In other embodiments, a display engine can be the same computing device as both the analytic engine and a capture engine.

### Example 11

### Exemplary Data Clouds

In any of the examples described herein, a data cloud is a collection of terms displayed in a weighted manner according to data associated with the terms. For example, as described above, a tag cloud, which is a type of data cloud, comprises a set of terms that are weighted according to the frequency that the terms appear in a dataset. For example, terms appearing more frequently in the data set can be displayed in a larger font.

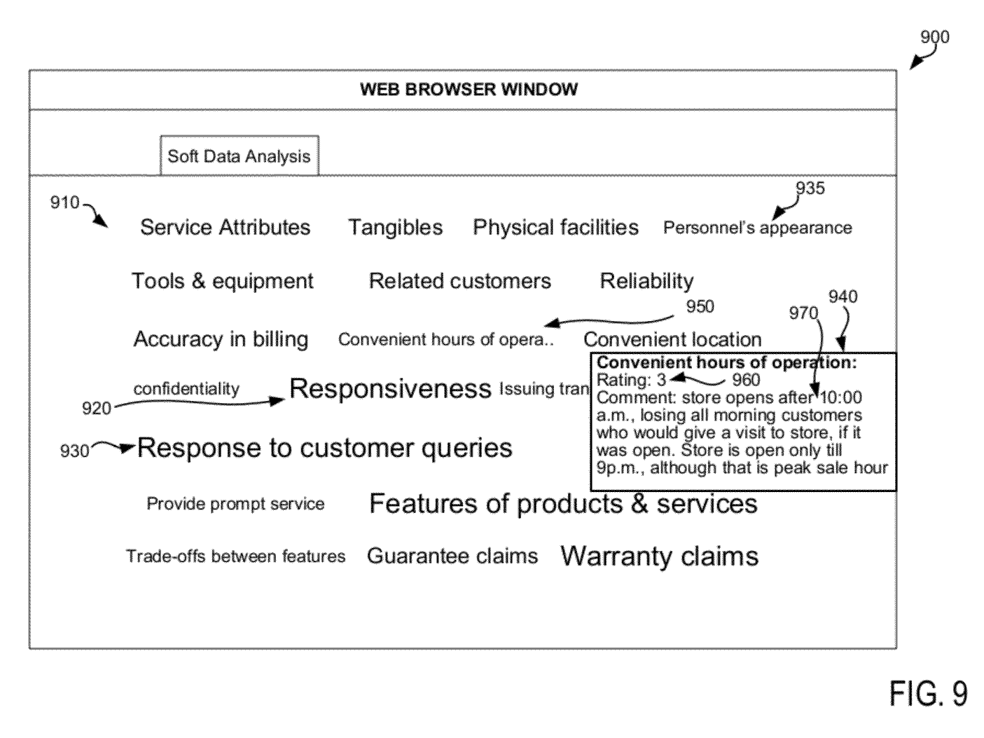

FIG. 9 is a screenshot 900 of an exemplary data cloud 910 based on aggregate data for service, product and enterprise attributes. The terms of the data cloud 910 comprise the names of the service, product and enterprise attributes presented in the capture engine interfaces shown in FIGS. 3-7. The attributes displayed in FIG. 9 are weighted accorded to the weighting data generated by the analytics engine. In the example, attributes having an overall high quantitative rating, such as Responsiveness 920 and Response to customer queries 930 are displayed with a larger font size, and attributes having a low overall quantitative ranking, such as Personnel's appearance 935 are displayed with a smaller font size.

In some embodiments, a data cloud can show service, product and enterprise weighted by color in addition to font size. For example, attributes having good, neutral or bad overall quantitative ratings could be colored green, yellow and red respectively. In addition, the color weighting of the attributes could be determined by the frequency of good, neutral or bad keywords occurring in the qualitative comments. Thus, attributes could be displayed with a first visual property weighted by quantitative soft data and a second visual property weighted by qualitative data.

In any of the data clouds described herein, all, a portion of, or a summary of the underlying aggregate data for any displayed attribute can be displayed. The underlying aggregate data for a displayed attributed is the aggregate data (which can include the original soft data) associated with the displayed service, product or enterprise attribute. The underlying aggregate data for a displayed attribute can be displayed when a displayed attribute is selected by a user. A displayed attribute can be selected by a user, for example, when a user clicks on a displayed attribute or rolls the mouse icon over a displayed attribute. Screenshot 900 shows a pop-up window 940 displaying the underlying aggregate data for the Convenient hours of operation attribute 950. The pop-up window 940 comprises a quantitative rating 960 and a qualitative comment 970. The quantitative rating 960 can be the average or median of the soft data corresponding to the selected attribute 950. In other embodiments, the pop-up window 940 can include minimum and maximum quantitative ratings, a histogram showing the distribution of quantitative ratings, and a list of some, or a portion of the individual qualitative comments. In further embodiments, further information relating to qualitative comments can be displayed such as which employee provided the comment, when the comment was entered, the store at which the comment was entered, etc. In some embodiments, qualitative comments can be displayed in the pop-up window 940 according to the weighting data. For example, the individual comments can be sorted according to the weighting (e.g., highest-rated comments or lowest-rated comments are listed first).

The data cloud 910 can represent aggregate soft data for a product, service or enterprise according to various constraints specified by an employee. For example, an employee can indicate that a data cloud be displayed based on aggregate data for only a specific store or set of stores (e.g., stores within a specific country, state, region, territory, city, or a specific store), by work shift (morning, evening, weekend), employee, customer characteristics (i.e., male/female; child/adult) and the like. A user can specify the constraints on the aggregate data used for generating a specific data cloud through the interface using various approaches known in the art (i.e., filling out fields in a pop-up window, etc.).

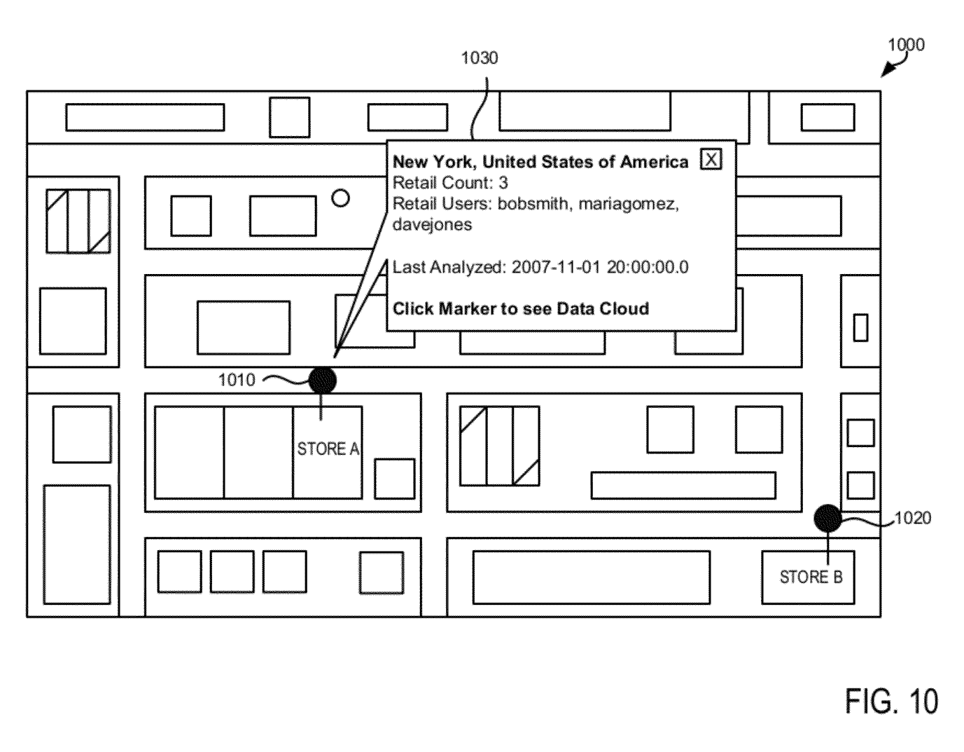

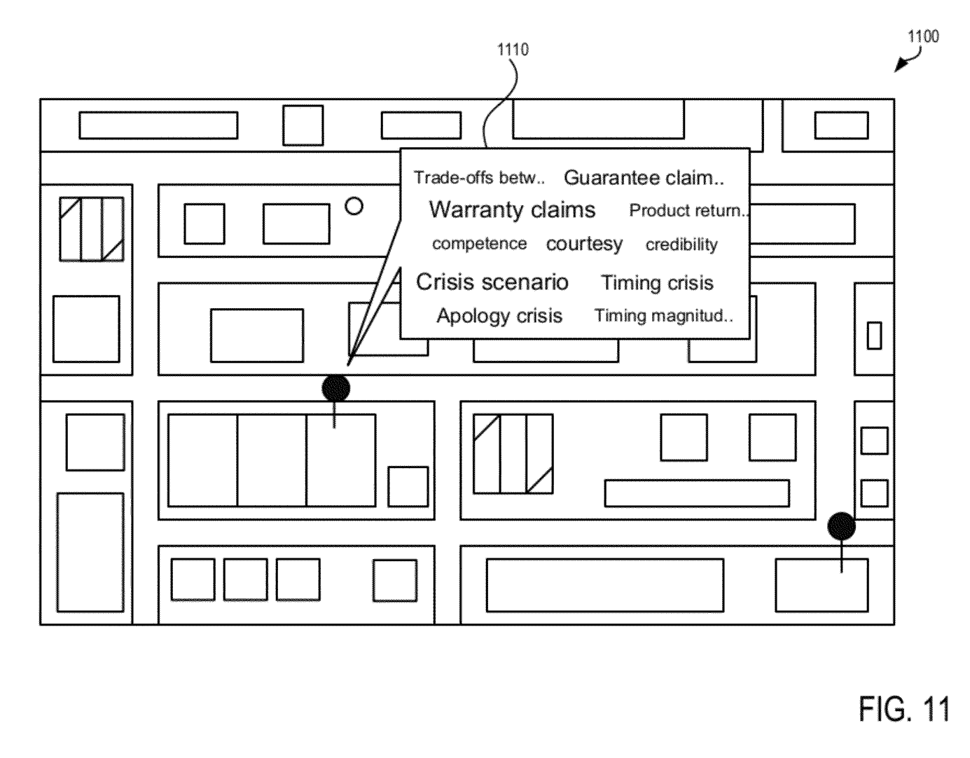

FIGS. 10-11 shows screenshots in which a user graphically selects a store for which the employee wants a data cloud to be produced. FIG. 10 show a screenshot 1000 of a map application showing a street-level map of a city containing two retail stores, stores A and B of an enterprise. The locations of the two stores are indicated by markers 1010 and 1020. In the figure, a user has moved the mouse icon over the pin 1010 corresponding to store A, causing a caption window 1030 to appear. The caption window 1030 comprises the store location (city, country), the number of and the usernames of retail employees who have entered soft data, and the date that the soft data was last analyzed. FIG. 11 shows a screenshot 1100 after the user has clicked on pin 1010. In place of the caption window, a data cloud 1110 has appeared containing a weighted list of service, product and enterprise attributes weighted for the selected store.

### Example 12

### Exemplary Method for Displaying a Data Cloud

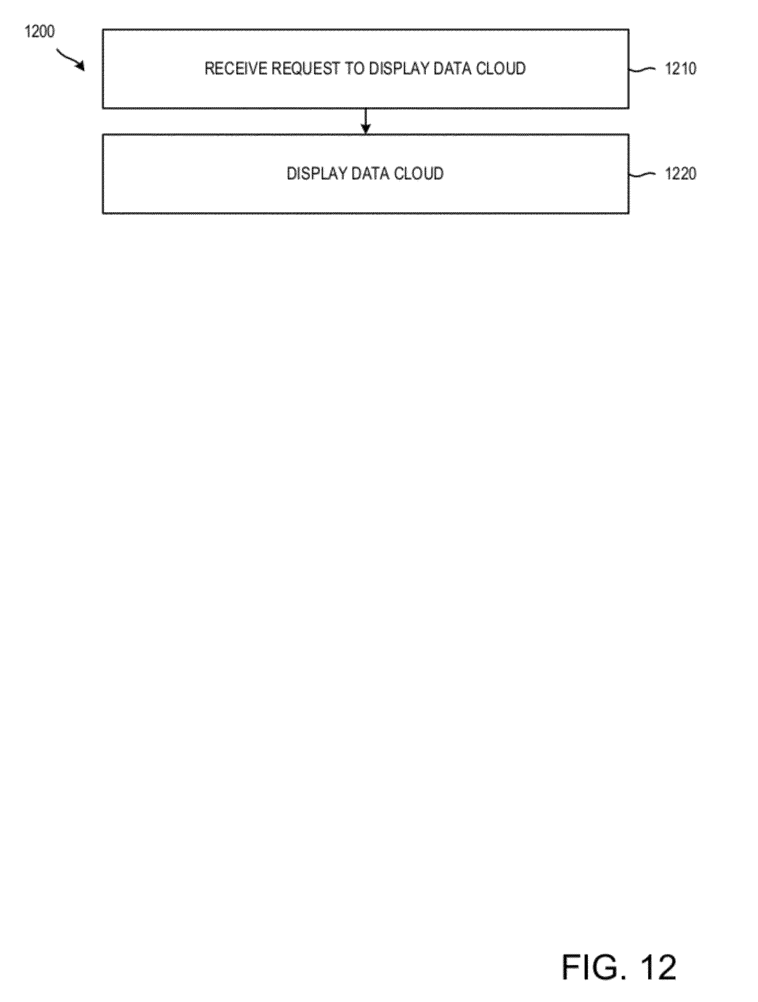

FIG. 12 is a flowchart of an exemplary method 1200 of displaying a data cloud.

At 1210, a display engine receives a request to display a data cloud.

At 1220, the display engine displays the requested data cloud.

The method 1200 can optionally include the display engine retrieving the aggregate data needed for generating the requested data cloud and/or requesting the analytics engine to generate aggregate data to support a display request.

### Example 13

### Data Cloud Utility

In any of the embodiment described herein, enterprise employees responsible for making decisions at the enterprise-level or for making decisions relating to an enterprise's products or services can use the data clouds generated as described herein to aid the decision maker in making decisions. For example, data clouds indicating negative feedback on a product's Price attribute can aid or enable a retail store enterprise employee in the decision to lower the price of the product. Data clouds indicating negative feedback on a product's Quality attribute can aid a manufacturer to decide to implement a design change or to investigate the quality issue further. Data clouds indicating positive feedback for the Reliability, Crisis scenarios and Empathy to individual service attributes can aid decisions relating to employee promotions or raises. The soft data collected, aggregated, analyzed and presented to enterprise employees in data cloud form can help enterprise employees in myriad other decisions affecting the enterprise.

Instead of, or in addition to, displaying soft data in a data cloud format, the soft data can be displayed in other formats. For example, soft data (e.g., after being aggregated and analyzed) can be displayed in a list format.

### Example 14

### Exemplary Retail Store Enterprise Embodiment

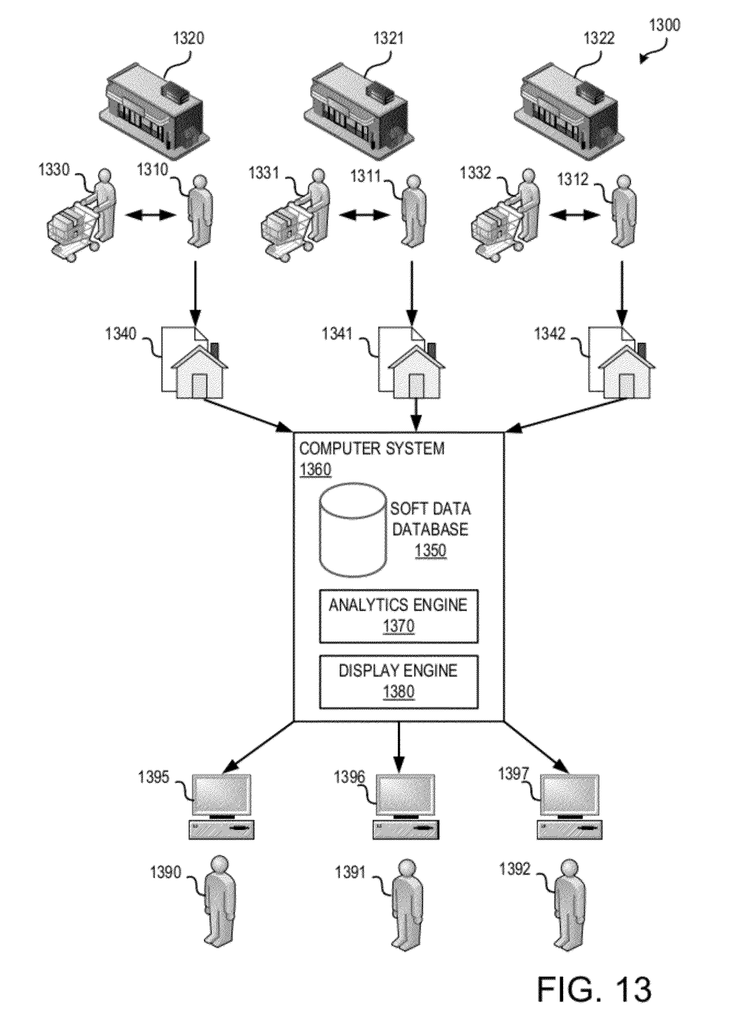

FIG. 13 illustrates an exemplary system 1300 for capturing and analyzing service, product or enterprise soft data using the techniques and tools described herein in the context of retail store enterprise. Retail store employees 1310-1312 working at retail stores 1320-1322 collect feedback from retail store customers 1330-1332, based on interactions between the employees 1310-1312 and the customers 1330-1332. This feedback is entered at capture engines 1340-1342 located in the stores 1320-1322. The soft data received at the capture engines 1340-1342 is stored at a soft data capture database 1350 located at the headquarters of the retail store enterprise. The soft data capture database 1350 is part of a computer system 1360 located at enterprise headquarters. The computer system 1360 also comprises the data analytics engine 1370 and the display engine 1380. Once a week, or at another periodic time interval, the captured soft data is aggregated and analyzed by a data analytics engine 1370, thereby generating aggregate data. Retail store analysts, managers and other decision makers 1390-1392 submit requests from desktop computers 1395-1397 to view data clouds based on the aggregate data. In response to the requests, the desktop computers 1395-1397 request the aggregate data from the computer system 1360, and the display engine 1380 causes the requested data clouds to be displayed on displays of the desktop computers 1395-1397.

### Example 15

### Exemplary Method for Displaying a Data Cloud

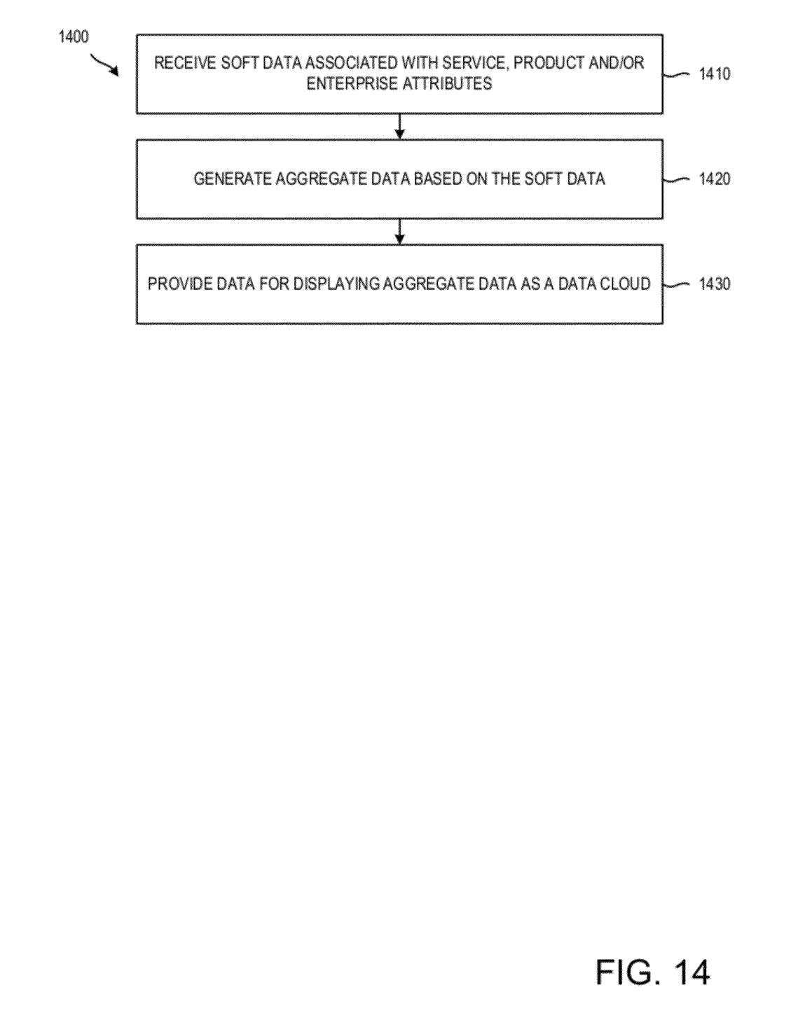

FIG. 14 is a flowchart of an exemplary method 1400 of receiving and aggregating soft data, and providing data for displaying a data cloud.

At 1410, soft data associated with one or more attributes of a service, product and/or enterprise is received at a computing device.

At 1420, aggregate data based on the soft data is generated. The aggregate data comprises weighting data for at least one of the service, product and/or enterprise attributes.

At 1430, data is provided for displaying the aggregate data at a display of the computing device as a data cloud. The data cloud comprises the service, product and/or enterprise attributes weighted according to the weighting data.

### Example 16

### Exemplary Computing Environment

The techniques and solutions described herein can be performed by software and/or hardware of a computing environment, such as a computing device. Exemplary computing devices include server computers, desktop computers, laptop computers, notebook computers, netbooks, tablet devices, mobile devices, smartphones and other types of computing devices (e.g., devices such as televisions, media players, or other types of entertainment devices that comprise computing capabilities such as audio/video streaming capabilities and/or network access capabilities). Additional computing devices include devices used by employees in a retail store context such as mobile bar code readers and checkout machines. The techniques and solutions described herein can be performed in a cloud-computing environment (e.g., comprising virtual machines and underlying infrastructure resources).

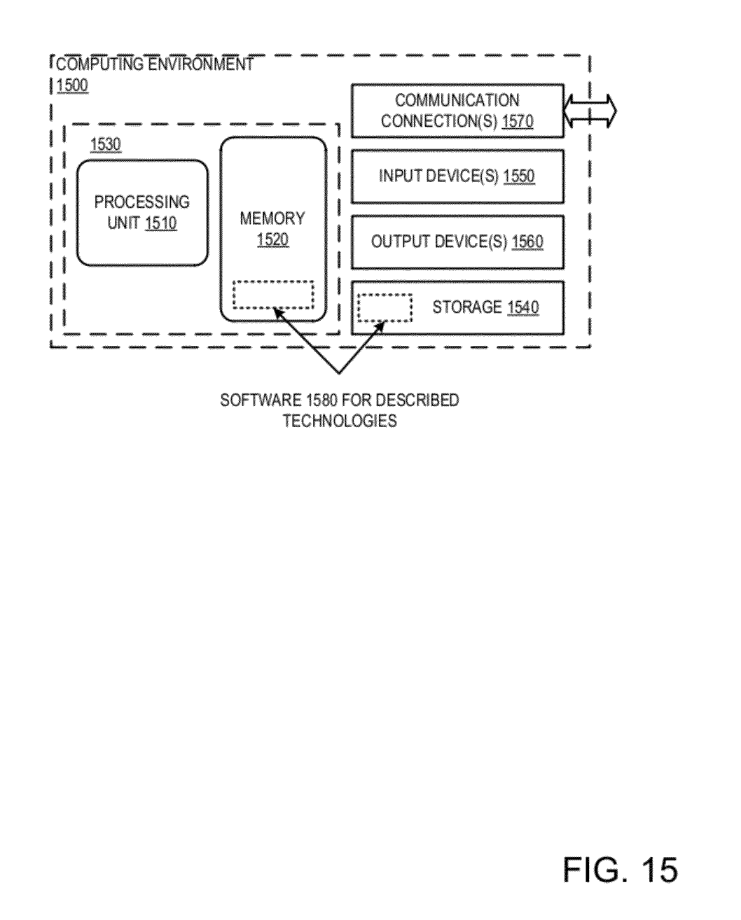

FIG. 15 illustrates a generalized example of a suitable computing environment 1500 in which described embodiments, techniques, and technologies can be implemented. The computing environment 1500 is not intended to suggest any limitation as to scope of use or functionality of the technology, as the technology can be implemented in diverse general-purpose or special-purpose computing environments. For example, the disclosed technology can be implemented using one or more computing devices (e.g., a server, desktop, laptop, hand-held device, mobile device, smartphone) each comprising a processing unit, memory and storage storing computer-executable instructions implementing the technologies described herein. The disclosed technology can also be implemented with other computer system configurations, including multiprocessor systems, microprocessor-based or programmable consumer electronics, network PCs, minicomputers, mainframe computers, a collection of client/server systems, and the like. The disclosed technology can also be practiced in distributed computing environments where tasks are performed by remote processing devices that are linked through a communications network, such as the Internet. In a distributed computing environment, program modules can be located in both local and remote memory storage devices.

With reference to FIG. 15, the computing environment 1500 includes at least one central processing unit 1510 and memory 1520. In FIG. 15, this most basic configuration 1530 is included within a dashed line. The central processing unit 1510 executes computer-executable instructions. In a multi-processing system, multiple processing units execute computer-executable instructions to increase processing power and as such, multiple processors can be running simultaneously. The memory 1520 can be volatile memory (e.g., registers, cache, RAM), non-volatile memory (e.g., ROM, EEPROM, flash memory, etc.), or some combination of the two. The memory 1520 stores software 1580 that can, for example, implement the technologies described herein. A computing environment can have additional features. For example, the computing environment 1500 includes storage 1540, one or more input devices 1550, one or more output devices 1560 and one or more communication connections 1570. An interconnection mechanism (not shown) such as a bus, a controller, or a network, interconnects the components of the computing environment 1500. Typically, operating system software (not shown) provides an operating environment for other software executing in the computing environment 1500, and coordinates activities of the components of the computing environment 1500.

The storage 1540 can be removable or non-removable, and includes magnetic disks, magnetic tapes or cassettes, CD-ROMs, CD-RWs, DVDs, or any other tangible storage medium which can be used to store information and which can be accessed within the computing environment 1500. The storage 1540 stores instructions for the software 1580, which can implement technologies described herein.

The input device(s) 1550 can be a touch input device, such as a keyboard, keypad, mouse, touchscreen, pen, or trackball, a voice input device, a scanning device, or another device, that provides input to the computing environment 1500. For audio, the input device(s) 1550 can be a sound card or similar device that accepts audio input in analog or digital form, or a CD-ROM reader that provides audio samples to the computing environment 1500. The output device(s) 1560 can be a display, printer, speaker, CD-writer or another device that provides output from the computing environment 1500.

The communication connection(s) 1570 enable communication over a communication medium (e.g., a connecting network) to other computing entities. The communication medium conveys information such as computer-executable instructions, compressed graphics information, or other data in a modulated data signal.

### Methods in Computer-Readable Media

In any of the examples described, any computer-executable instructions for implementing the disclosed techniques as well as any data created and used during implementation of the disclosed embodiments can be stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any commercially available computer, including smart phones or other mobile computing devices that include computing hardware). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

### DEFINITIONS

As used in this application and in the claims, the singular forms “a,” “an,” and “the” include the plural forms unless the context clearly dictates otherwise. Similarly, the word “or” is intended to include “and” unless the context clearly indicates otherwise. The term “comprising” means “including;” hence, “comprising A or B” means including A or B, as well as A and B together. Additionally, the term “includes” means “comprises.”

Additionally, the description sometimes uses terms like “produce” and “provide” to describe the disclosed methods. These terms are high-level abstractions of the actual computer operations that are performed. The actual computer operations that correspond to these terms will vary depending on the particular implementation and are readily discernible by one of ordinary skill in the art.

### Alternatives

The disclosed methods, apparatuses and systems should not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures cannot show the various ways in which the disclosed systems, methods and apparatuses can be used in conjunction with other systems, methods and apparatuses.

Having illustrated and described the principles of the illustrated embodiments, the embodiments can be modified in various arrangements while remaining faithful to the concepts described above. In view of the many possible embodiments to which the principles of the disclosed invention can be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

### Miscellaneous

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

We claim:

1. A method, comprising:
receiving, at a display engine, a request to display a data cloud comprising a plurality of service, product and/or enterprise attributes, the plurality of service, product and/or enterprise attributes weighted according to aggregate data, the aggregate data based on soft data associated with the plurality of service, product and/or enterprise attributes; and
displaying the data cloud on a display in communication with the display engine.

2. The method of claim 1, the method further comprising capturing the soft data at one or more capture engines.

3. The method of claim 2, the method further comprising:
the one or more capture engines presenting an interface to capture the soft data; and
storing the soft data in a soft data database.

4. The method of claim 2, further comprising:
via at least one of the one or more capture engines:
a user adding a new attribute to the plurality of service, product and enterprise attributes; and
capturing soft data related to the new attribute.

5. The method of claim 2, wherein the display engine is or is part of a first computing device, and the first computing device comprises at least one of the one or more capture engines.

6. The method of claim 2, wherein the one or more capture engines are located in one or more retail stores.

7. The method of claim 6, wherein the soft data is received from one or more retail store employees.

8. The method of claim 7, wherein the soft data is based on feedback provided to the one or more retail store employees by retail store customers.

9. The method of claim 2, the method further comprising:
aggregating the soft data; and
analyzing the soft data;
wherein the aggregate data is generated as a result of the aggregating and/or analyzing.

10. The method of claim 1, wherein the soft data comprises qualitative ratings data and qualitative comments data.

11. The method of claim 1, wherein respective of the plurality of service, product and/or enterprise attributes are associated with one or more visual properties, respective of the one or more visual properties being varied according to the aggregate data.

12. The method of claim 11, wherein the one or more visual properties comprise font size and/or color.

13. The method of claim 11, wherein the soft data comprises quantitative ratings for the plurality of service, product and/or enterprise attributes, and the one or more visual properties are based at least in part on the quantitative ratings.

14. The method of claim 11, wherein the soft data comprises qualitative comments for the plurality of service, product and/or enterprise attributes, and the one or more visual properties are based at least in part on the qualitative comments.

15. The method of claim 11, wherein the soft data comprises quantitative data and qualitative data for the plurality of service, product and/or enterprise attributes wherein a first visual property of the one or more visual properties is varied according to the qualitative data, and a second visual property of the one or more visual properties is varied according to the quantitative data.

16. The method of claim 15, wherein the first visual property is color and the second visual property is font size.

17. The method of claim 11, wherein the soft data comprises qualitative comments for the plurality of service, product and/or enterprise attributes the one or more visual properties are varied according to whether positive, neutral or negative keywords appear in the qualitative comments.

18. The method of claim 1, further comprising, in response to a user selecting one of the plurality of service, product and/or enterprise attributes displayed in the data cloud, displaying all, a portion of, or a summary of underlying aggregate data associated with the selected service, product and/or enterprise attribute.

19. The method of claim 17, wherein the underlying aggregate data comprises one or more quantitative ratings and/or qualitative comments weighted according to whether respective of the quantitative ratings and/or qualitative comments indicate positive, neutral or negative feedback.

20. The method of claim 1, wherein the method is provided as an Internet service.

21. One or more computer-readable storage media storing computer-executable instructions for causing one or more computing devices to perform a method, the method comprising:
receiving, at a first computing device, a request to display a data cloud at a display in communication with the first comprising device, the data cloud comprising a plurality of service, product and/or enterprise attributes; and
displaying the requested data cloud at the display, the plurality of service, product and/or enterprise attributes weighted according to aggregate data, the aggregate data based on soft data associated with the plurality of service, product and/or enterprise attributes.

22. The one or more computer-readable storage media of claim 20, the method further comprising:
receiving the soft data at one or more second computing devices; and
analyzing the soft data to generate aggregate data.

23. The one or more computer-readable storage media of claim 20, wherein the soft data comprises qualitative data and quantitative data and respective of the plurality of service, product and/or enterprise attributes are weighted according to the qualitative and quantitative data relating to respective of the plurality of service, product and/or enterprise attributes.

24. A computing device comprising:
a processing unit; and
a memory, the memory storing computer-executable instructions for causing the processing unit to carry out a method, the method comprising:
receiving soft data associated with one or more attributes of a service, product and/or enterprise;
generating aggregate data based on the soft data, the aggregate data comprising weighting data for at least one of the one or more service, product and/or enterprise attributes; and
providing data for displaying the aggregate data at a display of the computing device as a data cloud, the data cloud comprising the service, product and/or enterprise attributes weighted according to the weighting data.
